(19) United States
(12) Patent Application Publication
(10) Pub. No.: US 2010/0074155 A1
(43) Pub. Date: Mar. 25, 2010

(54) Mobile terminal and communication mode switching method thereof

(75) Inventors: Sang Woo Park, Chilgok-gun (KR); Woo Chan Park, Daegu Metropolitan City (KR); Young Jin Kim, Daegu Metropolitan City (KR); Si Hak Jang, Yongin-si (KR); Ung Jun Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/586,366

(22) Filed: Sep. 21, 2009

(30) Foreign Application Priority Data
Sep. 22, 2008 (KR) 10-2008-0092901

(51) Int. Cl. H04B 7/005

(52) U.S. Cl. 370/310

(57) ABSTRACT

A mobile terminal and communication mode switching method is capable of efficiently managing a data connection to a network via a wireless link when the mobile terminal switches between a master operation mode and a slave operation mode. A communication mode switching method determines whether a request for a second mode communication session is detected while the mobile terminal is in a first mode communication session with a network via a first interface. The system and method initializes and activates a second interface when a request for a second mode communication session is detected. The system and method also synchronize the first interface and the second interface, re-register a Mobile Internet Protocol (MIP) with the network, acquire an IP address as a consequence of the re-registration of the MIP, and communicate data with the network using the acquired IP address.

### CROSS-REFERENCE TO RELATED APPLICATION(S) AND CLAIM OF PRIORITY

The present application is related to and claims priority to an application entitled “MOBILE TERMINAL AND COMMUNICATION MODE SWITCHING METHOD THEREOF” filed in the Korean Intellectual Property Office on Sep. 22, 2008 and assigned Serial No. 10-2008-0092901, the contents of which are incorporated herein by reference.

### TECHNICAL FIELD OF THE INVENTION

The present invention relates to a wireless data communication system and, in particular, to a mobile terminal and communication mode switching method for managing data connection to a network via a wireless link especially when the mobile terminal switches between a master operation mode and a slave operation mode.

### BACKGROUND OF THE INVENTION

Typically, a mobile terminal can establish a data connection to a network in two operation modes: a master operation mode in which the mobile terminal itself receives the data communication service from the network with its browser through a wireless link; and a slave operation mode in which the mobile terminal bridges the data communication service to another terminal such as Personal Computer (PC) through a wire link. Depending upon the operation mode, different billing policies are applied for the data communication service. Further, the mobile terminal cannot operate in both operation modes simultaneously. Accordingly, if an operation mode switching event, i.e., a connection of another terminal, is detected while the mobile terminal is in data communication with the network, the mobile terminal terminates the connection to the network in order to change its operating mode.

The mode switching procedure of the mobile terminal is described with reference to FIGS. 1, 2A and 2B. FIG. 1 illustrates a block diagram of a wireless data communication system in which a terminal communicates with a network via a mobile terminal.

Referring to FIG. 1, the terminal T1 100 is connected to the network 500 via the mobile terminal MT1 200 as a wireless communication device. The network 500 includes a Base Station/Mobile Switching Center (BS/MSC) 300 and an Interworking Function (IWF) 400 coupled to the BS/MSC 300. The BS/MSC 300 is coupled to the IWF 400 via an L interface. The mobile terminal 200 is logically coupled to the terminal 100 via an rm interface and the BS/MSC 300 over a um interface. The terminal 100 can receive various data communication service from the network 500 via the mobile terminal 200.

If an rm interface connection of the terminal 100 is detected while the mobile terminal 200 is in data communication with the network 500, the mobile terminal 200 terminates the data communication session with the network 500. At this time, the mobile terminal 200 clears all the protocol information used in the data communication session. Next, the mobile terminal 200 reestablishes a connection to the network 500 for relaying data between the terminal 100 and the network 500 with new protocol information. This connection reestablishment process of the mobile terminal is described in more detail with reference to FIGS. 2A and 2B. FIG. 2A illustrates a diagram of an exemplary protocol stack of the mobile terminal 200 of FIG. 1 when the mobile terminal is operating in master operation mode. FIG. 2B illustrates a diagram of protocol stacks of the mobile terminal 200 and terminal 100 of FIG. 1 when the mobile terminal is operating in slave operation mode.

Referring to FIGS. 2A and 2B, if the rm interface connection of the terminal 100 is detected, the mobile terminal 100 terminates the browser running on an upper layer 201. Next, the mobile terminal 200 releases the connection with the network 500 on a network layer 202 such that a Mobile Internet Protocol (MIP) address assigned for the connection is withdrawn. Next, the mobile terminal 200 releases a Point-to-Point Protocol um (PPPum) connection with network 500 on a data link layer 203. Finally, the mobile terminal 200 releases a physical connection with the network 500 on the physical layer 204.

After the disconnection to network 500, the mobile terminal 200 establishes a connection with the terminal 100 through a cable on the physical layer 204. Once the physical connection is established, the mobile terminal 200 establishes a PPP uₘ interface connection (PPPum) with the network 500 and an PPP rₘ interface connection (PPPrm) with the terminal 200 on the data link layer 203. Next, the mobile terminal 200 re-registers the MIP with the network 500 and is assigned an IP address on the network layer 202. The terminal 100 is connected physically with the mobile terminal 200 with a connection protocol on the physical layer 104. The terminal 100 establishes an rₘ interface connection on the data link layer 103, and activates a browser application on the upper layer 101 for browsing data through the network 500.

When an rₘ interface connection of a device is detected while the mobile terminal 200 is in a data connection with the network, the conventional communication mode switching method releases the data connection to the network forcibly with the clearance of protocol information and reestablishes the data connection with new protocol information after the establishing the connection with the terminal. However, these release and reestablishment processes for the uₘ interface cause long processing delay. Also, the conventional data connection management wastes resources because of forced connection release with clearance of the reusable protocol information. From the user's viewpoint, the conventional communication mode switching method is disadvantageous since the user must wait until the connection with the network is completely released to select an operation mode of the mobile terminal.

### SUMMARY OF THE INVENTION

To address the above-discussed deficiencies of the prior art, it is a primary object to provide a communication mode switching method for a mobile terminal that is capable of efficiently managing the data connection especially when the mobile terminal switches between a master operation mode and a slave operation mode.

In accordance with an exemplary embodiment of the present invention, a communication mode switching method for a mobile terminal includes determining whether a request for a second mode communication session is detected while the mobile terminal is in a first mode communication session with a network via a first interface. The method also includes initializing and activating, when a request for a second mode communication session is detected, a second interface; synchronizing the first interface and the second interface; re-registering a Mobile Internet Protocol (MIP) with the network; acquiring an IP address as a consequence of the re-registration of the MIP; and communicating data with the network using the acquired IP address.

In accordance with another exemplary embodiment of the present invention, a communication mode switching method for a mobile terminal includes determining whether a request for a second mode communication session is detected while the mobile terminal is in a first mode communication session with a network via a first interface. The method also includes resynchronizing, when a request for a second mode communication session is detected, a Point-to-Point Protocol (PPP) link with the network; initializing and reactivating the first interface with the resynchronized PPP link; re-registering a Mobile Internet Protocol (MIP) with the network; acquiring an IP address as a consequence of the re-registration of the MIP; and communicating data with the network using the acquired IP address.

In accordance with another exemplary embodiment of the present invention, a mobile terminal includes a storage unit that stores a mobile browser running in a first mode communication session established via a first interface and a Mobile Internet Protocol (MIP) and a Point-to-Point Protocol (PPP) for initializing and activating the first interface and a second interface for establishing a second mode communication session. The mobile terminal also includes a radio communication unit that establishes a communication link for the first mode communication session and the second mode communication session with a network via at least one of the first and second interfaces; an external device connection unit that connects the mobile terminal to an external device via the second interface for the second mode communication session; and a control unit that initializes and activates the second interface when a request for the second mode communication session is detected, synchronizes the first interface and the second interface, re-registers a Mobile Internet Protocol (MIP) with the network, acquires an IP address as a consequence of the re-registration of the MIP, and communicates data with the network using the acquired IP address.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram illustrating a wireless data communication system in which a terminal communicates with a network via a mobile terminal;

FIG. 2A illustrates a diagram of an exemplary protocol stack of the mobile terminal of FIG. 1 when the mobile terminal operating in master operation mode;

FIG. 2B illustrates a diagram of protocol stacks of the mobile terminal and terminal of FIG. 1 when the mobile terminal operating in slave operation mode;

FIG. 3 illustrates a schematic block diagram of a configuration of a mobile terminal according to an exemplary embodiment of the present invention;

FIG. 4 illustrates a diagram of protocol stacks of the mobile terminal and the terminal connected via rm interface according to an exemplary embodiment of the present invention;

FIG. 5 illustrates a flowchart for a communication mode switching method for a mobile terminal when the mobile terminal switches between two operation modes according to an exemplary embodiment of the present invention; and

FIG. 6 illustrates a flowchart for a communication mode switching method for a mobile terminal when the mobile terminal switches between two operations modes according to another exemplary embodiment of the present invention.

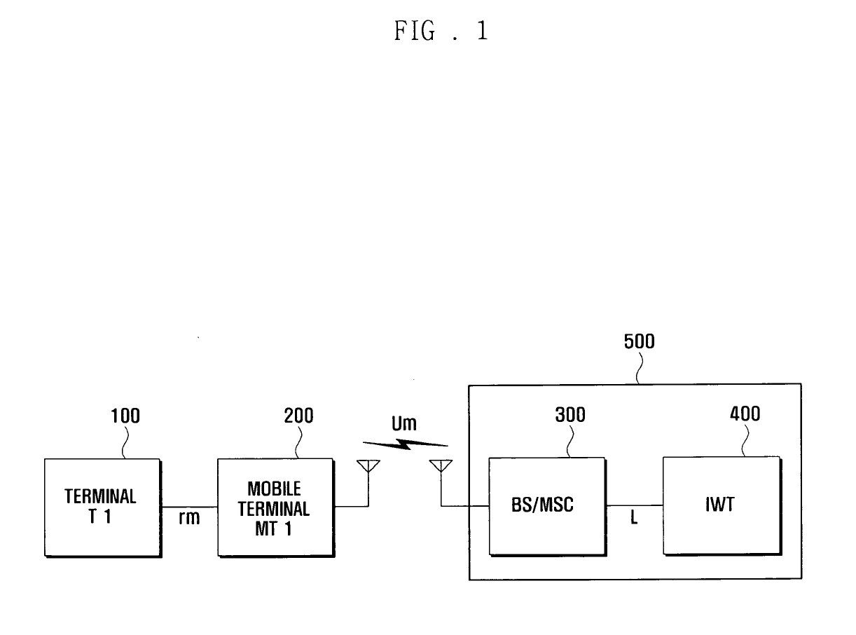

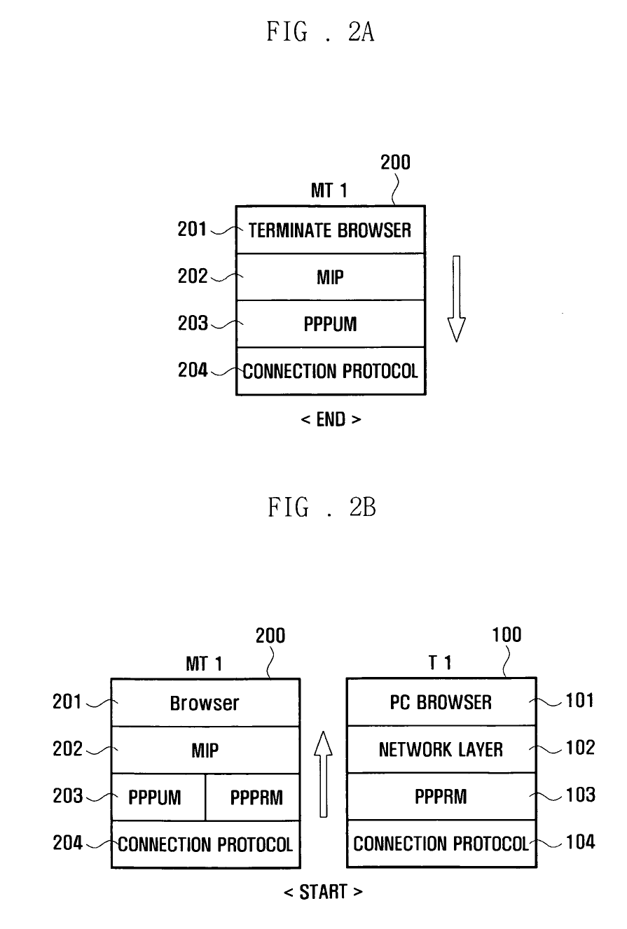

### DETAILED DESCRIPTION OF THE INVENTION

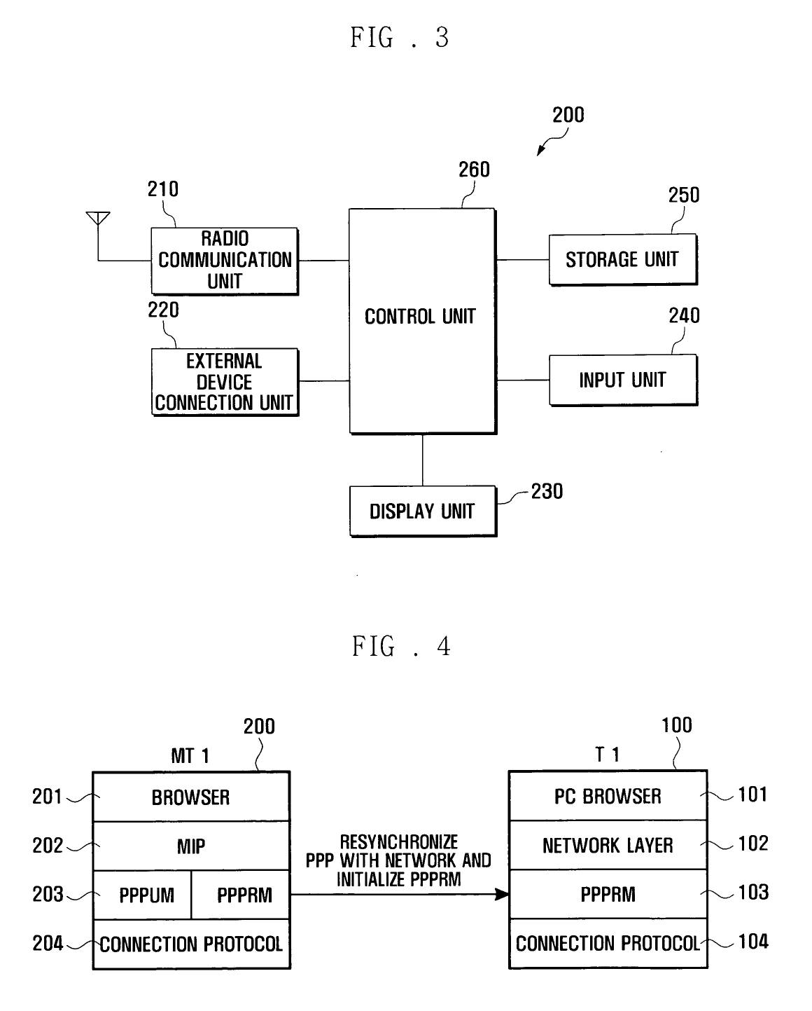

FIGS. 3 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

In the following descriptions, the term “rₘ interface” means a data communication interface between a mobile terminal and a device such as personal computer with cable connection, dial-up networking, or hyperterminal connection. In the following descriptions, it is assumed that the rₘ interface is a data communication interface between a fixed terminal and a mobile terminal via a wire link (i.e., cable).

In the following descriptions, the term “uₘ interface” means a data communication interface between a mobile terminal and a network via a wireless link. The mobile terminal communicates with the network via the uₘ interface regardless of the connection with the fixed terminal.

In the following descriptions, the “mobile browser” denotes an upper layer application program for users to browse web sites and download contents such as audio, video, and game.

In the following descriptions, the term “PC browser” denotes an upper layer application program for users to browse web sites and download contents such as audio, video, and game, and the web browser can include Internet Explorer, Windows update and download manager, MSN messenger, anti-virus program, and client application program interoperating with a server.

In the following descriptions, the term “terminal, or T1,” denotes any of devices that have data processing functionalities. Particularly, the terminal can include the devices that cannot communicate with a communication network directly but via a device having network connection ability. Representatively, the terminal can be a PC or a laptop computer.

In the following descriptions, the term “mobile terminal, or MT1,” denotes any of devices that can communicate with a network via a wireless link. Particularly, the mobile terminal can communicate data with the connected network directly and relay data between a device connected thereto and the network. Representatively, the mobile terminal can be a cellular phone. Here, the mobile terminal supports data communication based on the MIP.

In the following descriptions, the term “network” denotes a set of interconnected nodes to which the terminal and mobile terminal can connect. Particularly, the network can communicate with the terminal and mobile terminal via a PPP connection. Here, the PPP is a protocol that works on a point-to-point connection link for a Wide Area Network (WAN).

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

FIG. 3 illustrates a schematic block diagram of a configuration of a mobile terminal according to an exemplary embodiment of the present invention.

Referring to FIG. 3, the mobile terminal 200 includes a radio communication unit 210, an external device connection unit 220, a display unit 230, an input unit 240, a storage unit 250, and a control unit 260.

The radio communication unit 210 is responsible for processing radio signals carrying voice communication service, video communication service, Short Message Service (SMS), Multimedia Messaging Service (MMS), and their equivalent services.

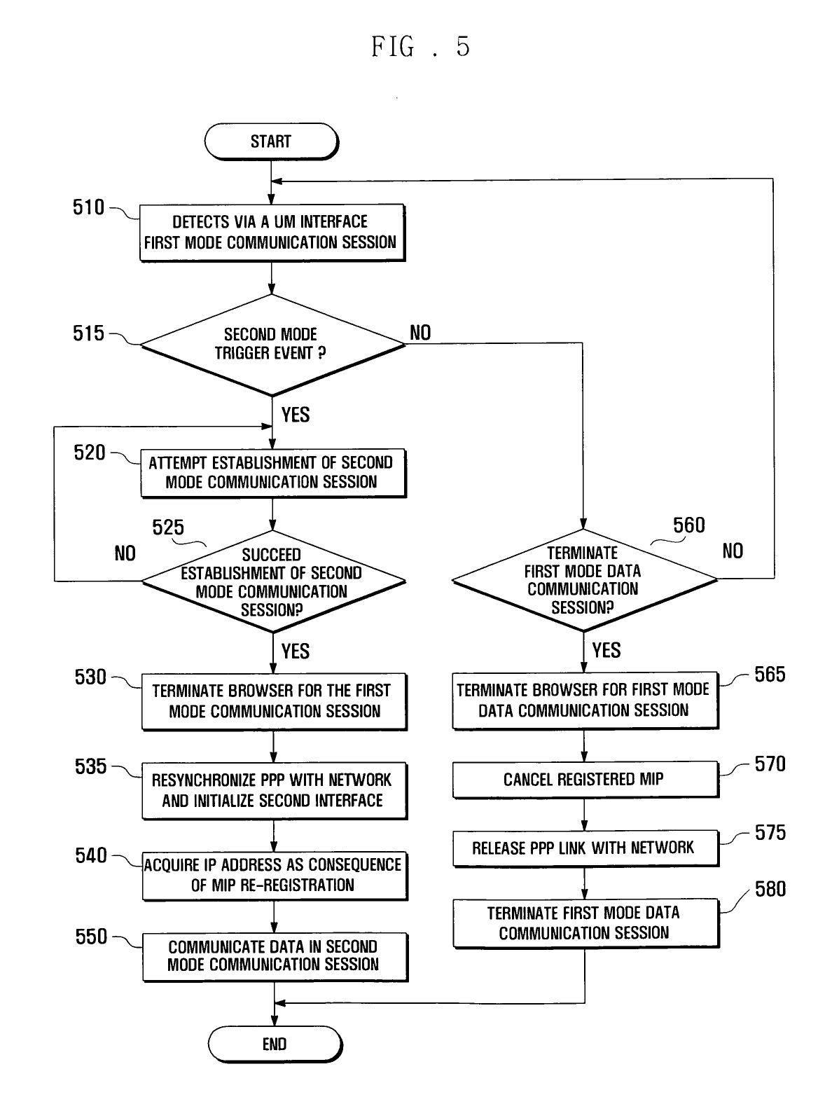

Particularly in an exemplary embodiment of the present invention, the radio communication unit 210 can transmit and receive the signals related to establishing a communication channel with the network 500 and carrying the data generated by the mobile browser or the PC browser. The radio communication unit 210 can work on the physical layer 204 of the protocol stack of the mobile terminal 200. The operations of the physical layer 204 are described later with reference to FIG. 4 in detail.

The external device connection unit 220 allows an external device, e.g., a fixed terminal, to connect to the mobile terminal 200. The external device connection unit 220 includes a connection port such that the external device is connected via a cable and supplies the signal received from the external device to the control unit 260. Here, the external device connection unit 220 can work on the physical layer 204 of the protocol stack of the mobile terminal 200. The operations of the physical layer 204 are described later with reference to FIG. 4 in detail.

The display unit 230 displays operation status and menu screens of the mobile terminal 200. The display unit 230 can be implemented with a Liquid Crystal Display (LCD). In case of being implemented with a LCD supporting a touch screen function, the display unit 230 can work as a part of the input unit 240. Particularly in this embodiment, the display unit 230 displays a browser screen when the mobile browser is running under the control of the control unit 260. When an external device, i.e., terminal 100, is connected to the mobile terminal 200 by means of the external device connection unit 220 through a cable, the display unit 230 displays a popup window alerting the connection of the terminal 200 under the control of the control unit 260 such that the user can determine whether to permit data communication with the terminal 200 via the rₘ interface. The popup window provides connection options selectable such that the user can select a connection option. Once the mobile terminal 200 is connected to the terminal 100 by means of the external device connection unit 220 and the data communication is permitted via the rₘ interface, the display unit 230 outputs an announcement message notifying of the slave operation mode for use of the rₘ interface.

The input unit 240 is provided with a plurality of alphanumeric keys for inputting alphabetic and numeric data and a plurality of function keys for executing various functions of the mobile terminal 200 and transfers the signal corresponding to the key input to the control unit 260. The input unit 240 can be implemented with a touch screen, a normal keypad, or QWERTY keypad, along with separated supplementary function keys and soft keys. Particularly in an exemplary embodiment of the present invention, the input unit 240 is provided with a function key for establishing a connection to the network 500. The input unit 240 is configured such that the user navigates across options provided in the popup window appearing when an external device is connected through the external device connection unit 220 by manipulating navigation keys and a selection key.

The storage unit 250 stores application programs including the mobile browser and application data generated while the application programs are running. Particularly in an exemplary embodiment of the present invention, the storage unit 250 stores protocols operating on the layers constituting the protocol stack. These protocols activate protocol entities for communicating with corresponding peer entities of the network when a communication link is established between the mobile terminal 200 and the network 500. Particularly in an exemplary embodiment of the present invention, the protocols include a PPP for initializing and establishing the uₘ and rₘ interface connections.

The storage unit 250 also stores the MIP for maintaining a static IP address even when the mobile terminal 200 moves from the network 500 to another network. The storage unit 250 stores Network Access Identifier (NAI) per application program accessing the network 500. The NAI can be used for identifying the applications accessing the network 500.

The control unit 260 controls general operations of the mobile terminal 200. Particularly in an exemplary embodiment of the present invention, the control unit 260 configures the control stack when a data communication is request through the input unit 240. When the communication operation mode is changed while the mobile terminal 200 is in connected state with the network 500, the control unit 260 reconfigures the protocol stack for slave operation mode. For example, if a second interface connection is detected at the external device connection unit 220 while the mobile terminal 200 is in communication with the network via a first interface, the control unit 260 reconfigures the protocol stack to establish a communication link with the device connected via the second interface without termination of the communication link on the first interface. Next, the control unit 260 synchronizes the first and second interfaces and performs resynchronization with the network 500. Once the resynchronization with the network 500 is successfully done, the control unit 260 reregisters the MIP with the network 500 and acquires a reassigned IP address, whereby the mobile terminal 200 relays the data between the rₘ interface and the uₘ interface. How to resynchronize the MIP and PPP with the network 500 is described with reference to FIG. 4 illustrating structures of the protocol stacks of the mobile terminal 100 and the terminal 200.

FIG. 4 illustrates a diagram of protocol stacks of the mobile terminal and the terminal connected via rₘ interface according to an exemplary embodiment of the present invention.

Referring to FIG. 4, the protocol stack of the terminal 100 is composed of an application layer 101 in which application programs installed in the mobile terminal 100 are running, a network layer 102 that is responsible for handling IP addressing and delivering data from lower layer to the application layer, a data link layer 130 that is responsible for initializing the rₘ interface and establishing communication channel on the rₘ interface by means of a PPP (i.e., PPPrm), and a physical layer 104 which is responsible for establishing a connection to the mobile terminal 200 via a physical medium, such as cable by means of a connection protocol.

The protocol stack of the mobile terminal 100 is composed of an application layer 201 that is responsible for providing service to the user by means of application programs, such as Graphic User Interface, a network layer 202 that is responsible for handling IP addressing and routing data by means of network protocols, such as MIP, a data link layer that is responsible for initializing the rₘ interface and establishing a communication channel with the terminal 100 on the rₘ interface by means of a PPP (i.e., PPPrm) and a uₘ interface and establishing a communication channel with the network 500 on the uₘ interface by means of a PPP (i.e., PPPum), and a physical layer that is responsible for establishing a connection to the mobile terminal 200 via a physical medium such as cable by means of a connection protocol and converts the bits of data into electrical signal.

Assuming that the control unit 260 of the mobile terminal 200 detects an rₘ interface connection of the terminal 100 while the mobile terminal is in the middle of a communication with the network 500 via a uₘ interface, the control unit 260 terminates the browser running on the application layer 201 and initializes the rₘ interface on the data link layer 230 to establish a data link with terminal 100 on the rₘ interface. Thereafter, the control unit 260 synchronizes the uₘ interface with the rₘ interface and then resynchronizes the PPP link with the network 500. Then, the control unit 260 reregisters the MIP with the network 500 on the network layer 202 and acquires an updated user IP address from the network. At this time, since the MIP operates in the network model mode, the connection protocol operating in the physical layer is not reconfigured.

When the terminal 100 is connected to the mobile terminal 200 through a cable, the rₘ interface is initialized for connection to the mobile terminal 200 in the data link layer 103, and a PC browser is activated in the application layer for data communication.

As described herein above, when an rₘ interface connection of the terminal 100 is detected while the mobile terminal is in communication with the network 500 via the uₘ interface, the mobile terminal 200 changes its operation mode for relaying the data between the rₘ and uₘ interfaces. Such operation mode switching occurs in an identical manner when the rₘ interface connection of the terminal to the mobile terminal 200 is released or the data link on the rₘ interface is forcibly released for direct communication with the network 500. Although the protocol stack is depicted with four (4) protocol layers in FIG. 4, the structure of protocol stack is not limited thereto. For example, the protocol stack can be structured with more than four (4) protocol layers. Additionally, each protocol layer can be replaced with equivalent protocol layer. Further, each protocol layer can be divided into multiple sub-layers, and the multiple layers can be integrated into a single layer.

The management of a data connection with the network when the operation mode of the mobile terminal is changed is described hereinafter.

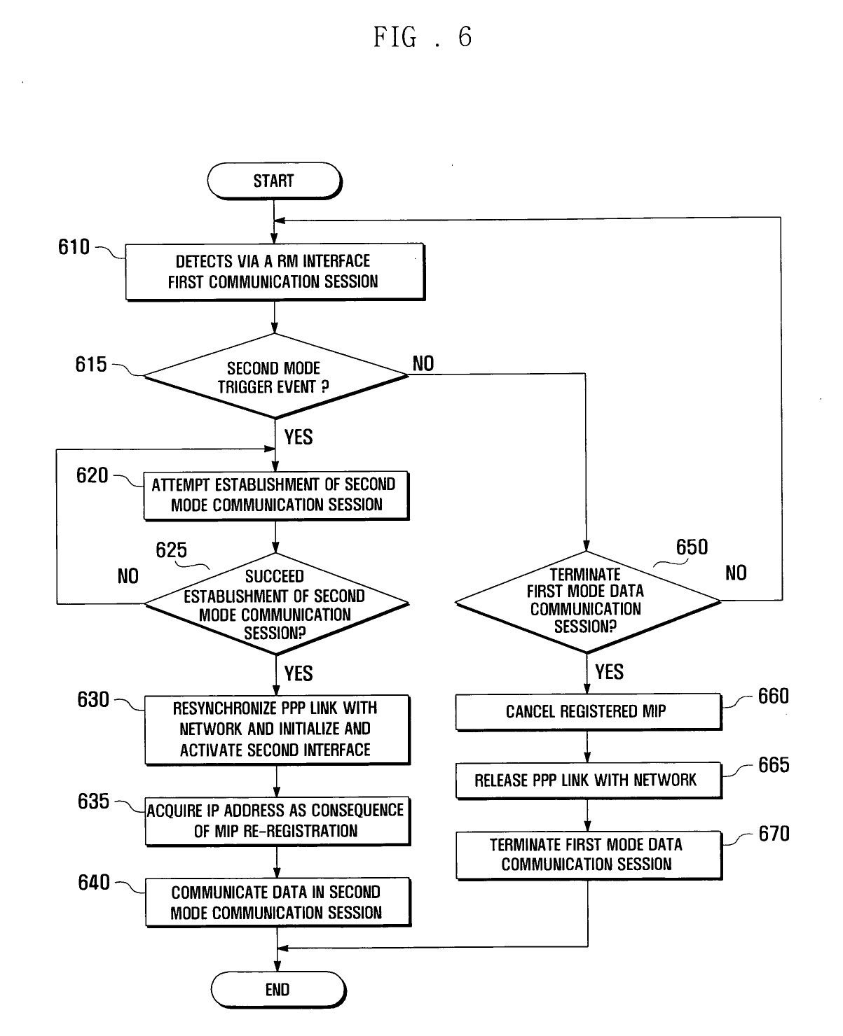

FIG. 5 illustrates a flowchart for a communication mode switching method for a mobile terminal when the mobile terminal switches between two operation modes according to an exemplary embodiment of the present invention.

Referring to FIG. 5, the control unit 260 of the mobile terminal 200 detects that the mobile terminal 200 is in the middle of a first mode communication session with the network 500 via a first interface (in step 510). Here, it is assumed that the first interface is a uₘ interface between the mobile terminal 200 and the network 500 and the first mode communication session is set up via the uₘ interface. In the first mode communication session, the mobile terminal 200 operates in master operation mode in which the mobile terminal 200, as a host, communicates data with the network 500 by means of a mobile browser running in the mobile terminal 200. The mobile browser can be a web browser customized for the mobile terminal 220 to search and download contents such as audio, video, and games.

During the first mode communication session, the control unit 260 monitors to detect an event and, if an event is detected, determines whether the event is a second mode communication session trigger event (in step 515). Here, it is assumed that the second interface is an rₘ interface and the second mode communication session is set up via the rₘ interface (between the terminal 100 and the mobile terminal 200) and the uₘ interface (between the mobile terminal 200 and the network 500) in series. In the second mode communication session, the mobile terminal 200 operates in slave operation mode in which the terminal 100, as the host, communicates with the network 500 by means of its PC browser through the rₘ and uₘ interfaces bridged by the mobile terminal 200. The PC browser can be a web browser including Internet explorer, anti-virus program, a messenger program, a windows update program, and a data download program.

If the event detected, while the mobile terminal 200 is operating in the master operation mode, is a second mode communication session trigger event at step 515, the control unit 260 attempts to establish the second mode communication session (in step 520). For example, assuming that the PC browser is a game downloader program and the control unit 260 detects a connection of the terminal 100 through a cable while the mobile terminal 200 is downloading a game from the network 500 by means of the game downloader program, the control unit 260 regards the connection of the terminal 100 as an event for requesting the second mode communication session.

Although the detection on the connection of the terminal 100 through a cable is regarded as the second mode communication session trigger event, the second mode communication session trigger event is not limited thereto. For example, the second mode communication session can be triggered by a user command input through the input unit 240 of the mobile terminal 200. More particularly, when an external device is connected to the external device connection unit 220, the control unit 260 controls the display unit 230 to display a popup window having communication options selectable such that the user can select one of the communication options. If the user selects an option for the second mode communication session by manipulating the input unit 240, the control unit 260 executes operations for establishing the second mode communication session. The communication options displayed by the display unit 230 can include a Universal Serial Bus (USB) memory connection, a slave operation mode connection (second mode communication session) for using the mobile terminal 200 as a modem, and a remote terminal connection for allowing the terminal to control the data stored in the mobile terminal 200.

At step 520, the control unit 260 calls the terminal 100 using a dial-up networking to establish a connection with the terminal 100 and waits for a response signal from the terminal 100 to determine whether the rₘ interface connection is successfully established (525). If no response signal is received from the terminal 100, i.e., the rₘ interface connection attempt fails; the control unit 260 retries to establish the rₘ interface connection with the terminal 100. Although it is depicted, in FIG. 5, that the control unit 260 retries the rₘ interface connection to the terminal 100 when the first rₘ interface connection has failed, the control unit 260 can control to maintain the first mode communication session according to a user command or a preset configuration.

Otherwise, if the rₘ interface connection is successfully established at step 525, the control unit 260 terminates the mobile browser running for the first mode communication session (in step 530). For example, if the mobile terminal 200 is in the middle of downloading a game, the control unit 260 stops downloading the game.

After terminating the mobile browser, the control unit 260 resynchronizes the PPP link with the network 500 and initializes the second interface (i.e., the rₘ interface) to establish a data link with the terminal 100 (535). At this time, the control unit 260 performs synchronization between the rₘ interface and the uₘ interface and resynchronizes the PPP link with the network 500.

In order to synchronize the PPP link between the mobile terminal 200 and the terminal 100, the terminals 200 and 100 can exchange configure-request packets and configure-ACK packets. Also, the control unit 260 of the mobile terminal 200 can transmit a configure-request packet to the network 500 and receive a configure-ACK packet from the network 500 to resynchronize the PPP link. Thereafter, the control unit 260 checks the PC browser's NAI transmitted by the terminal 100 and sends the NAI to the network 500 using the configure-request packet.

The control unit 260 acquires an updated IP by reregistering the MIP with the network 500 and configures a routing path for data communication (in step 540). More particularly, once the PPP resynchronization is successfully acquired, the control unit 260 sends an MIP re-registration request packet to the network 500 by means of the radiocommunication unit 210. The MIP re-registration request packet carries the NAI of the PC browser received from the terminal 10. With the receipt of the MIP re-registration response packet transmitted by the network 500, the control unit 260 determines that the MIP is successfully re-registered. Once the MIP is successfully re-registered, the control unit 260 acquires the update IP from the network 500.

As a result, the second mode communication session is established such that the control unit 260 relays the data received from the terminal 100 to the network 500 and the data received from the network 500 to the terminal 100 (in step 550).

Returning to step 515, if the event is not the second mode communication session trigger event, the control unit 260 determines whether the detected event is a first mode communication session termination event (in step 560). If the detected event is not the first mode communication session termination event, the process goes to step 510.

If the detected event is the first mode communication session termination event, the control unit 260 terminates the mobile browser running for the first mode communication session (in step 565). Next, the control unit 260 releases the registration of the MIP with the network 500 (in step 570) and releases the PPP link with the network 500 (in step 575). Accordingly, the first mode communication session is terminated (in step 580).

The communication mode switching method has been described herein above under the assumption that the first mode communication session is established on the uₘ interface as the first interface and the second mode communication session is established on the uₘ interface as the first interface and the rₘ interface as the second interface. Hereinafter, the communication mode switching method is described under the assumption that the first mode communication session is established on the uₘ interface as the first interface and the rₘ interface as the second interface and the second data communication is established on the uₘ interface as the first interface.

FIG. 6 illustrates a flowchart for a communication mode switching method for a mobile terminal when the mobile terminal switches between two operations modes according to another exemplary embodiment of the present invention.

Referring to FIG. 6, the control unit 520 of the mobile terminal 200 detects a first mode communication session with the network 500 via a first interface and a second interface (in step 610). It is assumed that the first interface is a uₘ interface between the mobile terminal 200 and the network 500 and the second interface is an rₘ interface between the mobile terminal 200 and an external device, i.e., the terminal 100, and the first mode communication session is set up via the uₘ and rₘ interfaces in series. In the first mode communication session, the mobile terminal 200 operates in slave mode in which the mobile terminal 200 relays data between the terminal 100 and the network 500 such that the terminal 100 communicates with the network 500 by means of a PC browser running in the terminal 100. The PC browser can be any of Internet explorer, an anti-virus program, a messenger program, a windows update program, and a data download program.

During the first mode communication session, the control unit 260 monitors to detect an event and, if an event is detected, determines whether the event is a second mode communication session trigger event (in step 615). Here, the second mode communication session is established with the involvement of only the uₘ interface as the first interface. In the second mode communication session, the mobile terminal 200 operates in the master operation mode in which the mobile terminal 200, as the host, communicates with the network 500 by means of its mobile browser through the uₘ interface. The mobile browser can be a web browser customized for the mobile terminal 200 to search and download contents such as audio, video, and games.

The second mode communication session trigger event can be a user input for activating the mobile browser running in the mobile terminal 200 for accessing the network 500. That is, if the user inputs a command for activating the mobile browser or a content download application through the input unit 240, the control unit 260 determines that the second mode communication session is triggered.

If the event detected while the mobile terminal 200 is operating in the slave operation mode is a second mode communication session trigger event at step 615, the control unit 260 attempts to establish the second mode communication session (in step 620) by calling the network 500. Next, the control unit 260 waits for receiving a response from the network to determine whether the second mode communication session is established successfully (in step 625). If no response signal is received from the network 500, the control unit 260 retries to establish the second mode communication session. Although it is depicted, in FIG. 6, that the control unit 260 retries the establishment of the second mode communication session with the network 500 when the first attempt has failed, the control unit 260 can control to maintain the first mode communication session according to a user command or a preset configuration.

Otherwise, if the second mode communication session is successfully established at step 625, the control unit 260 resynchronizes the PPP link with the network 500 and initializes and activate the first interface (i.e., the uₘ interface) with the network 500 (in step 630). In order to reacquire the synchronization of the PPP link, the mobile terminal 200 and the network 500 can exchange configure-request packets and configure-ACK packets. Also, the control unit 260 of the mobile terminal 200 checks the NAI of the mobile browser and transmits the NAI to the network 500 using the configure-request packet. At this time, the control unit 260 can transmit a first mode communication session termination packet to the terminal 100 that is connected to the mobile terminal 200 through the external device connection unit 220.

Once the PPP link is established and the first interface is activated successfully, the control unit 260 acquires an updated IP by reregistering the MIP with the network 500 and configures a routing path for data communication (in step 635). More particularly, the PPP resynchronization is successfully acquired, the control unit 260 of the mobile terminal 200 sends an MIP re-registration request packet to the network 500 by means of the radio communication unit 210. The control unit 260 checks the NAI of the mobile browser selected in the mobile terminal and transmits the NAI in the MIP re-registration request packet. With the receipt of the MIP re-registration response packet, the control unit 260 determines that the MIP is successfully re-registered. Once the MIP is successfully re-registered, the control unit 260 acquires the updated IP from the network 500.

Accordingly, the second mode communication session is established such that the mobile terminal 200 communicates data with the network 500 (in step 640).

Returning to step 615, if the event is not the second mode communication session trigger event, the control unit 260 determines whether the detected event is a first mode communication session termination event (in step 650). The first mode communication session termination event can include a receipt of a data communication termination request packet from the terminal 100 or a detection of a communication session termination command input through the input unit 240. If the detected event is not the first mode communication session termination event, the process goes to step 610.

Otherwise, if the detected event is the first mode communication session termination event, the control unit 260 cancels the registered MIP (in step 660). Then, the control unit 260 terminates the PPP link with the network 665 and, as a consequence, the first mode communication is terminated (in step 670).

As described above, when a new communication session requiring involvement of an rm interface and a uₘ interface is requested in the middle of a current communication session established via a uₘ interface, the mobile terminal and communication mode switching method of the present invention enables replacing the current communication session with the new communication session by reusing the resources allocated on the uₘ interface for the current communication session. Also, when a new communication session requiring involvement of only the uₘ interface is requested in the middle of a current communication session established via the uₘ and an rₘ interface in series, the mobile terminal and communication mode enables replacing the current communication session with the network communication by re-using protocol resources allocated on the uₘ interface for the current communication. Since the protocol resources are re-used for switching the communication mode of the mobile terminal, the communication mode switching can be done without protocol reconfiguration. As a result, the mobile terminal can quickly establish a new communication session, resulting in user convenience. Also, the reuse of the protocol resources protects waste of resource.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communication mode switching method for a mobile terminal, the method comprising:
determining whether a request for a second mode communication session is detected while the mobile terminal is in a first mode communication session with a network via a first interface;
initializing and activating, when a request for a second mode communication session is detected, a second interface;
synchronizing the first interface and the second interface;
re-registering a Mobile Internet Protocol (MIP) with the network;
acquiring an IP address as a consequence of the re-registration of the MIP; and
communicating data with the network using the acquired IP address.

2. The method of claim 1, wherein initializing and activating a second interface comprises:
terminating a browser running in the first mode communication session;
synchronizing a Point-to-Point Protocol (PPP) link with a device connected via the second interface as a host in the second mode communication session.

3. The method of claim 2, wherein initializing and activating the second interface further comprises using the PPP link.

4. The method of claim 3, wherein re-registering a MIP with the network comprises:
sending the network an MIP re-registration request packet containing a Network Access Identifier (NAI) of a browser to run in the second mode communication session.

5. The method of claim 4, wherein re-registering a MIP with the network further comprises acquiring, when an MIP re-registration response packet is received, an updated IP address as a result of the MIP-registration.

6. The method of claim 2, wherein the first mode communication session is established via a uₘ interface between the mobile terminal and the network.

7. The method of claim 6 wherein the second mode communication session is established via an rₘ interface between the device and the mobile terminal and the uₘ interface between the mobile terminal and the network in series.

8. A communication mode switching method for a mobile terminal, the method comprising:
determining whether a request for a second mode communication session is detected while the mobile terminal is in a first mode communication session with a network via a first interface;
resynchronizing, when a request for a second mode communication session is detected, a Point-to-Point Protocol (PPP) link with the network;
initializing and reactivating the first interface with the resynchronized PPP link;
re-registering a Mobile Internet Protocol (MIP) with the network;
acquiring an IP address as a consequence of the re-registration of the MIP; and
communicating data with the network using the acquired IP address.

9. The method of claim 8, wherein initializing and reactivating the first interface comprises transmitting a first mode communication session termination packet to a device, wherein the device is coupled to the mobile terminal as a host for the first mode communication session.

10. The method of claim 8, wherein the first mode communication session is established via an rₘ interface between the device and the mobile terminal and a uₘ interface between the mobile terminal and the network in series.

11. The method of claim 10, wherein the second mode communication session is established via the uₘ interface between the mobile terminal and the network.

12. A mobile terminal comprising:
a storage unit configured to store a Mobile Internet Protocol (MIP) and a mobile browser for running a first mode communication session established via a first interface and a Point-To-Point Protocol (PPP) for initializing and activating the first interface and a second interface to establish the first mode communication and a second mode communication session that is establish via the second interface;
a radio communication unit configure to establish a communication link with a network via at least one of the first and second interfaces, the communication link configured for the first mode communication session and the second mode communication session; and
a control unit configured to initialize and activate the second interface when a request for the second mode communication session is detected during the first mode communication session, synchronizes the first interface and the second interface, re-registers a Mobile Internet Protocol (MIP) with the network, acquires an IP address as a consequence of the re-registration of the MIP, and communicates data with the network using the acquired IP address.

13. The mobile terminal of claim 12, wherein the control unit terminates a PC browser, running in the first mode communication session, when the request for the second mode communication session is detected, the control unit configured to synchronize a Point-to-Point Protocol (PPP) link with the external device connected via the second interface as a host in the second mode communication session, and wherein the control unit initializes and activates the second interface using the PPP link.

14. The mobile terminal of claim 13, wherein the control unit is configured to send the network a Mobile Internet Protocol (MIP) re-registration request packet containing a Network Access Identifier (NAI) of a browser to run in the second mode communication session and acquire, when a MIP re-registration response packet is received, an updated IP address as a consequence of the MIP-registration.

15. The mobile terminal of claim 13, wherein the first mode communication session is established via a u, interface between the mobile terminal and the network, and the second mode communication session is established via an r, interface between the device and the mobile terminal and the uₘ interface between the mobile terminal and the network in series.

16. The mobile terminal of claim 13, wherein the browser includes a content downloader for downloading audio, video, and game contents and a mobile web browser for browsing web sites.

17. The mobile terminal of claim 13, wherein the PC browser includes a web browser, a windows updater and downloader, a messenger, an anti-virus program.
